(19) United States
(12) Patent Application Publication
(10) Pub. No.: US 2010/0035687 A1
(43) Pub. Date: Feb. 11, 2010

(54) DISPLAY DEVICE

(75) Inventors: CHENG-HAO CHOU, Tu-Cheng (TW); XIAO-GUANG LI, Shenzhen City (CN); KUAN-HONG HSIEH, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (TW); HON HAI PRECISION INDUSTRY CO., LTD., Tu-Cheng (TW)

(21) Appl. No.: 12/426,930

(22) Filed: Apr. 20, 2009

(30) Foreign Application Priority Data
Aug. 6, 2008 (CN) 200810303562.8

(51) Int. Cl. G06F 17/00

(52) U.S. Cl. 463/37; 463/43

(57) ABSTRACT

A display device is provided. The display device comprises a storage unit, a motion sensing unit, a motion state determining unit, a parameter determining unit. The storage unit stores a program executed to provide at least one game object having at least one parameter. The motion sensing unit is capable of detecting a shaking motion imparted to the display device by a user. The motion state determining unit is capable of determining a shaking characteristic of the shaking motion according to signals from the motion sensing unit. The parameter value control unit changes a value of the at least one parameter according to the shaking characteristic of the shaking motion.

### BACKGROUND

1. Technical Field

The present disclosure relates to display devices and, more particularly, to a shake responsive display device.

2. Description of Related Art

Many portable computing devices, such as personal digital assistants (PDAs), cellular phones, and portable media players, enable users to play games, for example, games that require a user to roll simulated dice and make moves based upon the outcome of the dice roll. One common dice game for Motorola and Nokia mobile phones is “Jacado Dice”, a game in which users place bets and press buttons to toss the simulated dice.

In general, such devices are usually compact in size and the buttons are usually small. Users may have uncomfortable feelings in their fingers after a long time operation of such small buttons. Therefore, there is a need to provide a device to resolve the problems stated above.

### BRIEF DESCRIPTION OF THE DRAWINGS

FIG. 1 is a block diagram of a display device in accordance with an exemplary embodiment of the present disclosure.

FIG. 2 is an assembled, cross-sectional view of the vibration switch shown in FIG. 1 in accordance with an exemplary embodiment of the present disclosure.

FIG. 3 is an assembled, cross-sectional view of the vibration switch of FIG. 1., taken from the line II-II in FIG. 2.

FIG. 4 is an assembled, cross-sectional view of the vibration switch of FIG. 1 in accordance with another exemplary embodiment of the present disclosure.

FIG. 5 shows a relationship table in accordance with an exemplary embodiment that is stored in a storage unit of the handheld device of FIG. 1.

FIG. 6 shows game objects displayed on the display device of FIG. 1.

FIG. 7 shows game objects displayed on the display device of FIG. 1.

### DETAILED DESCRIPTION

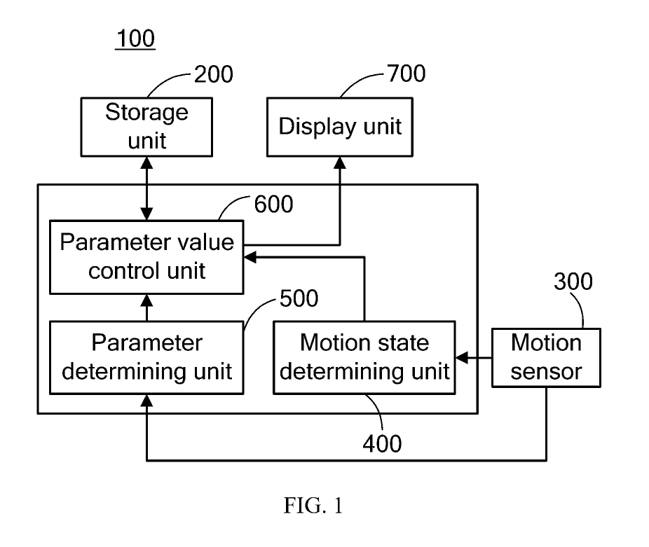

FIG. 1 shows a block diagram of a display device 100 in accordance with an exemplary embodiment of the present disclosures. The display device 100 can be a cellular phone, a PDA, or a digital photo frame. In an exemplary embodiment, the display device 100 is a digital photo frame and includes a storage unit 200, a motion sensor 300, a motion state determining unit 400, a parameter determining unit 500, a parameter value control unit 600, and a display unit 700.

The storage unit 200 can be any appropriate storage medium, such as a read-only memory or a random-access memory, and stores a game program. The game program is used to be executed to provide at least one type of game object. In this embodiment, the at least one type of game object includes a plurality of air bubbles in water and includes at least one game parameter. The at least one game parameter is used to control the size of the air bubbles and is a function of the shaking characteristic of the shaking of the display device 100, which will be better understood from the following description.

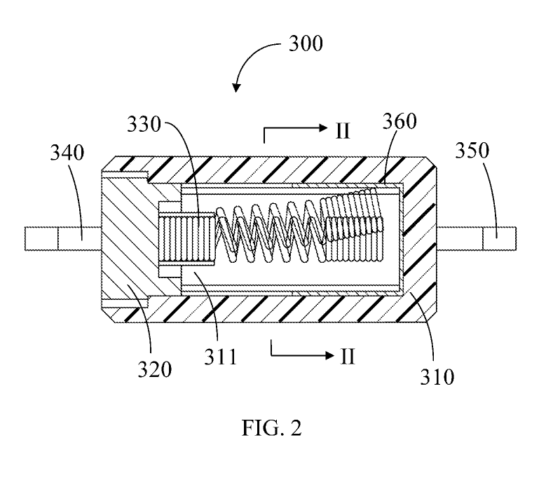

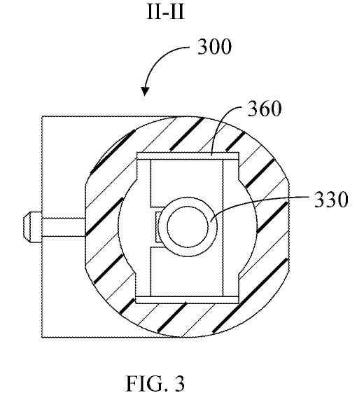

Referring to FIGS. 2 and 3, in an exemplary embodiment, the motion sensor 300 is a vibration switch and comprises a housing 310, a side cap 320, a coil spring 330, a first contact terminal 340, a second contact terminal 350, and a metal sheet 360.

A chamber 311 is formed in the housing 310. The side cap 320 is attached to the opening end of the housing 310 to cover the chamber 311. The coil spring 330 is received in the chamber 311 in a cantilevered way, that is, one end of the coil spring 330 is attached to the side cap 320 and is electrically coupled to the first contact terminal 340, while the other end of the coil spring 330 is floated.

The metal sheet 360 is positioned on the inner surface of the chamber 311 and electrically coupled to the second contact terminal 350. Specifically, the metal sheet 360 is configured in such a way that the coil spring 330 is capable of deflecting and contacting the metal sheet 360 when being shaken in a predetermined direction.

When the housing 310 is shaken in a direction approximately perpendicular to the metal sheet 360, the coil spring 330 deflects and the floating end of the coil spring is capable of coming into contact with the metal sheet 360, which makes the vibration switch 300 change from an electrically open state to an electrically closed state. Thus, during the shaking of the housing 310, the vibration switch 300 keeps changing its state between the electrically closed state and the electrically open state. After the shaking of the housing 310 has ceased, the coil spring 330 recovers its original shape and position and the vibration switch 300 returns to the electrically open state.

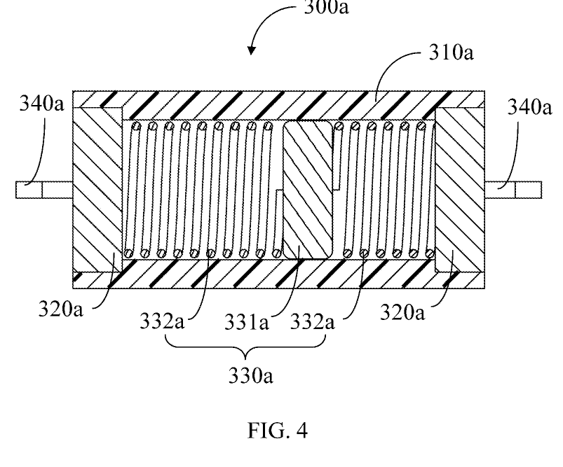

Referring to FIG. 4, in another embodiment, the vibration switch 300a includes a housing 310a, two side caps 320a, a movable member 330a, and two contact terminals 340a. A chamber 311a is formed in the housing 310a. The two side caps 320a are attached to two ends of the housing 310a respectively to cover the chamber 311a, and are electrically coupled to the two contact terminals 340a, respectively.

The movable member 330a comprises an inertial weight 331a and two coil springs 332a. The coil springs 332a are attached to two ends of the inertial weight 331a respectively and are in contact with the two side caps 320a. When the housing 310a is shaken in a longitudinal direction, the inertial weight 331a moves in the chamber 311a and one of the two coil springs 332a is capable of being out of contact with one of the two side caps 320a, making the vibration switch 300a change from an electrically open state to an electrically closed state.

The motion state determining unit 400 receives signals from the vibration switch 300 and determines the shaking characteristic of the shaking of the display device 100. In an exemplary embodiment, the shaking characteristic is a shaking level indicating how strongly the display is shaken. Specifically, the more strongly the display device 100 is shaken, the higher the shaking level is.

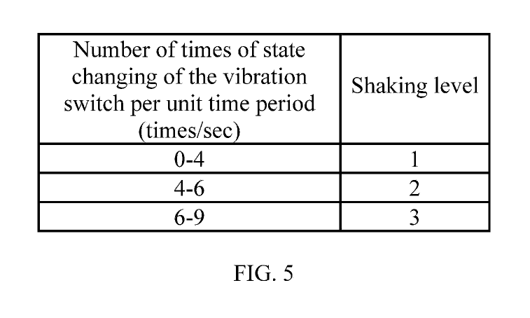

The shaking level is determined according to the duration time of the shaking of the display device 100 and the number of times of state changing of the vibration switch 300 in the duration time. As shown in FIG. 5, the relationship between the shaking level and the number of times of state changing of the vibration switch 300 per unit time period is defined in a relationship table stored in the storage unit 200.

The parameter determining unit 500 receives signals from the vibration switch 300 and determines the game parameter that corresponds to the shaking of the display device 100. The parameter value control unit 600 receives signals from the vibration switch 300 and the parameter determining unit 500 and determines the value of the game parameter according to the function relationship between the game parameter and the shaking characteristic. The game program is executed based on the value of the game parameter determined by the parameter value control unit.

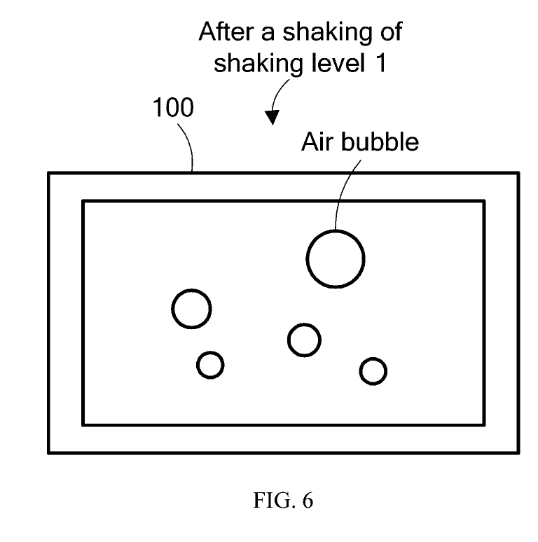

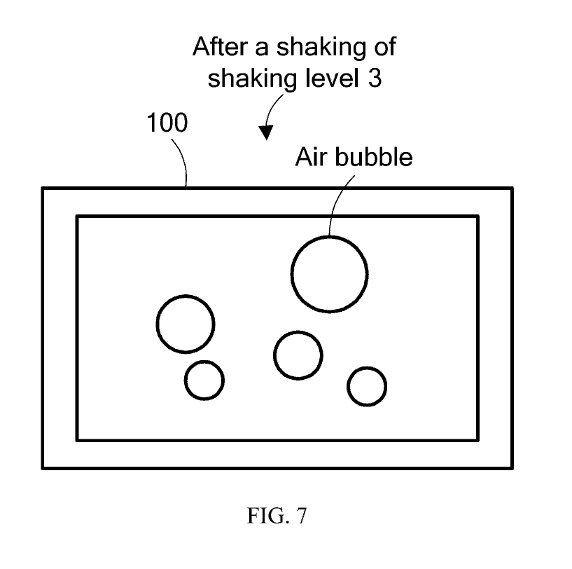

As a result, in this embodiment, users can obtain different size of the air bubbles by shaking the display device 100 with different shaking levels. For example, as shown in FIGS. 6 and 7, the more strongly the display device 100 is shaken, the bigger the air bubbles are displayed.

Although the motion sensor 300 in the embodiment described above is a vibration switch, the motion sensor 300 may be an acceleration sensor. In case of an acceleration sensor, acceleration value of the shaking of the display device 100 can be obtained and the shaking level of the shaking of the display device 100 is determined based on the acceleration value. The acceleration value, as used herein, is a mean value of the acceleration of the shaking of the handheld device 100.

It is understood that the game object may have more game parameters. For example, the game object may also have a game parameter used to control the number of the air bubbles. In such case, another vibration switch may be used to associate with such additional game parameter.

While various embodiments have been described and illustrated, the disclosure is not to be constructed as being limited thereto. Various modifications can be made to the embodiments by those skilled in the art without departing from the true spirit and scope of the disclosure as defined by the appended claims.

What is claimed is:

1. A display device comprising:
a storage unit storing a program executed to provide at least one game object having at least one parameter;
a motion sensing unit capable of detecting a shaking motion imparted to the display device by a user;
a motion state determining unit capable of determining a shaking characteristic of the shaking motion according to signals from the motion sensing unit; and
a parameter value control unit changing a value of the at least one parameter according to the shaking characteristic of the shaking motion.

2. The display device according to claim 1, wherein the motion sensing unit is a vibration switch.

3. The display device according to claim 2, wherein the vibration switch comprises a coil spring, a first contact terminal, and a second contact terminal, the coil spring is electrically coupled to the first contact terminal and is capable of deflecting and contacting the second contact terminal during the shaking of the display device.

4. The display device according to claim 3, wherein the coil spring deflects when the housing is shaken in a predetermined direction.

5. The display device according to claim 2, wherein the vibration switch comprises a chamber, a movable member with two spring ends, and two contact terminals, the moveable member is received in the chamber, the two spring ends contact the first contact terminal and the second contact terminal respectively, at least one of the spring ends is capable of disengaging one of the two contact terminals during the shaking of the display device.

6. The display device according to claim 5, wherein the movable member comprises an inertial weight and two coil springs, the two coil springs are attached to two ends of the inertial weight respectively.

7. The display device according to claim 1, wherein the at least one game object is a virtual air bubble in water.

8. The display device according to claim 1, wherein the display device is a digital photo frame.
